(19) United States
(12) Patent Application Publication
(10) Pub. No.: US 2026/0118616 A1
(43) Pub. Date: Apr. 30, 2026

(54) CABLE REEL STRUCTURALLY CONFIGURED TO PREVENT UNINTENTIONAL UNWINDING OF CABLE FROM THE REEL

(71) Applicant: PPC BROADBAND, INC., East Syracuse, NY (US)

(72) Inventor: Raymond PALINKAS, Canastota, NY (US)

(73) Assignee: PPC BROADBAND, INC., East Syracuse, NY (US)

(21) Appl. No.: 19/004,718

(22) Filed: Dec. 30, 2024

Related U.S. Application Data
(60) Provisional application No. 63/615,894, filed on Dec. 29, 2023.

(51) Int. Cl. G02B 6/44

(52) U.S. Cl. CPC G02B 6/4457

(57) ABSTRACT

A reel structurally configured to prevent unintentional unwinding of cable from the reel. The reel may include a drum portion, a first flange portion configured to be coupled with q first end of the drum portion, a second flange portion configured to be coupled with a second end of the drum portion, and a retaining portion configured to extend into a space between the first and the second flange portions. The retaining portion may be structurally configured to permit payout of cable wound on the drum portion from the space between the first and the second flange portions. The retaining portion may be structurally configured to provide a radially inward biasing force that exceeds a radially outward biasing force of cable wound on the drum portion so as prevent unwinding of cable from the drum portion via the space between the first and the second flange portions.

### RELATED APPLICATION

This application claims the benefit of U.S. Provisional Patent Application No. 63/615,894, filed December 29, 2023, the entire disclosure of which is herein fully incorporated by reference.

### TECHNICAL FIELD

The present disclosure generally relates to cable reels, and more particularly relates to cable reels for fiber optic cable that include a retaining portion configured to prevent unintentional unwinding of cable from the reel.

### BACKGROUND

The process of installing cable (e.g., coaxial cable, fiber optic cable, category cable, electrical wiring cable, and the like) into structures, for example, new homes, is relatively time consuming and can lead to frustrating entanglements or other shortcomings in the distribution of the cable. For example, a cable reel may include cable wound thereon that has a tendency to unintentionally unwind itself from the reel. Such unintentional unwinding, or cable runaway, can cause tangling of the cable itself and/or tangling with a caddy upon which the cable reel is mounted for payout.

Some conventional cable reels are provided from the manufacturer with a plastic wrapping therearound so as to avoid unintentional unwinding of cable from the reel during transport and storage. The electrician installing the cable into the building or structure is required to remove the plastic wrapping before paying out the cable for installation, which can cause inconvenience and removes the unwinding protection.

It may be desirable to provide a cable reel that is configured to prevent unintentional unwinding, or runaway, of cable from the reel. For example, it may be desirable to provide a cable reel with a retaining portion that is configured to maintain the cable on the reel so as to prevent unintentional unwinding of cable from the reel. It may be desirable to provide a cable reel with such a retaining portion so as to eliminate the need for a plastic wrapping around the cable and/or the reel prior to payout.

### SUMMARY

The present disclosure provides a reel structurally configured to prevent unintentional unwinding of cable from the reel.

In some embodiments, the reel may include a cylindrical drum portion having a first end portion and a second end portion opposite the first end portion.

In some embodiments, the drum portion may be structurally configured to have a cable wound thereon.

In some embodiments, the reel may include a first flange portion structurally configured to be coupled with the first end portion of the drum portion. In some embodiments, the reel may include a second flange portion structurally configured to be coupled with the second end portion of the drum portion.

In some embodiments, the reel may include a first retaining portion structurally configured to extend from the first flange portion into a space between the first flange portion and the second flange portion.

In some embodiments, the reel may include a second retaining portion structurally configured to extend from the second flange portion into a space between the first flange portion and the second flange portion.

In some embodiments, the first retaining portion may include a plurality of first projecting portions positioned along at least a portion of a circumference of the first circular flange portion and may be structurally configured to extend into the space between the first flange portion and the second flange portion.

In some embodiments, the second retaining portion may include a plurality of second projecting portions positioned along at least a portion of a circumference of the second circular flange portion and may be structurally configured to extend from the second flange portion into the space between the first flange portion and the second flange portion.

In some embodiments, at least a portion of the retaining portion may be structurally configured to deflect radially outward to permit payout of cable wound on the drum portion from the space between the first flange portion and the second flange portion.

In some embodiments, the first and second retaining portions may be structurally configured to provide a radially inward biasing force that exceeds a radially outward biasing force of cable wound on the drum portion so as prevent unwinding of cable from the drum portion via the space between the first flange portion and the second flange portion.

In some embodiments, each of the first and second projecting portions may have a leading edge portion and a trailing edge portion opposite the leading edge portion, and may be curved inward in a direction from the leading edge portion to the trailing edge portion.

In some embodiments, the leading edge portion of each of the first and second projecting portions may taper away from a direction of rotation of the reel as the cable pays out.

In some embodiments, the first retaining portion may extend around the entire circumference of the first flange portion.

In some embodiments, the plurality of first projecting portions may be formed integrally with the first flange portion and bent into the space between the first flange portion and the second flange portion.

In some embodiments, the plurality of second projecting portions may be formed integrally with the second flange portion and bent into the space between the first flange portion and the second flange portion.

In some embodiments, a reel may be structurally configured to prevent unintentional unwinding of cable from the reel. In some embodiments, the reel may include a drum portion having a first end and a second end, a first flange portion configured to be coupled with the first end of the drum portion, a second flange portion configured to be coupled with the second end of the drum portion, and a retaining portion configured to extend into a space between the first flange portion and the second flange portion.

In some embodiments, the retaining portion may include a first retaining portion extending from the first flange portion into the space between the first flange portion and the second flange portion and second retaining portion extending from the second flange portion into the space between the first flange portion and the second flange portion.

In some embodiments, the retaining portion may be structurally configured to permit payout of cable wound on the drum portion from the space between the first flange portion and the second flange portion.

In some embodiments, the retaining portion may be structurally configured to provide a radially inward biasing force that exceeds a radially outward biasing force of cable wound on the drum portion so as prevent unwinding of cable from the drum portion via the space between the first flange portion and the second flange portion.

In some embodiments, the first retaining portion may include a plurality of first projecting portions formed integrally with the first flange portion and bent into the space between the first flange portion and the second flange portion.

In some embodiments, the second retaining portion may include a plurality of second projecting portions formed integrally with the second flange portion and bent into the space between the first flange portion and the second flange portion.

In some embodiments, the first retaining portion may include a first plurality projecting portions. In some embodiments, each projecting portion may have a leading edge portion that tapers away from a direction of rotation of the reel as the cable pays out.

In some embodiments, the first retaining portion may extend around the entire periphery of the first flange portion.

In some embodiments, at least of portion of the retaining portion may be structurally configured to deflect radially outward to permit payout of cable wound on the drum portion.

In some embodiments, a reel may be structurally configured to prevent unintentional unwinding of cable from the reel. In some embodiments, the reel may include a drum portion having a first end and a second end, a first flange portion configured to be coupled with the first end of the drum portion, a second flange portion configured to be coupled with the second end of the drum portion, and a retaining portion configured to extend into a space between the first flange portion and the second flange portion.

In some embodiments, the retaining portion may be structurally configured to permit payout of cable wound on the drum portion from the space between the first flange portion and the second flange portion

In some embodiments, the retaining portion may be structurally configured to provide a radially inward biasing force that exceeds a radially outward biasing force of cable wound on the drum portion so as prevent unwinding of cable from the drum portion via the space between the first flange portion and the second flange portion.

In some embodiments, the retaining portion may be formed integrally with the first flange portion.

In some embodiments, the retaining portion may be positioned at an outer periphery of the first flange portion and is bent into the space between the first flange portion and the second flange portion.

In some embodiments, the retaining portion may include a second retaining portion formed integrally with the second flange portion.

In some embodiments, the second retaining portion may be positioned at an outer periphery of the second flange portion and is bent into the space between the first flange portion and the second flange portion.

In some embodiments, the retaining portion may include a plurality of projecting portions. In some embodiments, each projecting portion may have a leading edge portion that tapers away from a direction of rotation of the reel as the cable pays out.

In some embodiments, the retaining portion may include a plurality of projecting portions. In some embodiments, each projecting portion may have a leading edge portion and a trailing edge portion. In some embodiments, the projecting portion may be curved inward in a direction from the leading edge portion to the trailing edge portion.

In some embodiments, the retaining portion may extend around the entire periphery of the first flange portion.

In some embodiments, at least a portion of the retaining portion may be structurally configured to deflect radially outward to permit payout of cable wound on the drum portion.

In some embodiments, the retaining portion may include a first retaining portion extending from the first flange portion into the space between the first flange portion and the second flange portion and a second retaining portion extending from the second flange portion into the space between the first flange portion and the second flange portion.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

Further advantages and features of the present disclosure will become apparent from the following description and the accompanying drawings, to which reference is made. In which are shown:

FIG. 1 is an isometric view of a conventional cable reel.

FIG. 2 is side view of a conventional cable reel with cable wound thereon.

FIG. 3 is a front view of an exemplary cable reel in accordance with various aspects of the disclosure.

FIG. 4 is a side view of the cable reel of FIG. 3 with cable wound thereon.

FIG. 5 is a front view of another exemplary cable reel in accordance with various aspects of the disclosure.

FIG. 6 is a front view of another exemplary cable reel in accordance with various aspects of the disclosure.

FIG. 7 is a side view of another exemplary cable reel in accordance with various aspects of the disclosure.

FIG. 8 is a side view of another exemplary cable reel in accordance with various aspects of the disclosure.

FIG. 9 is a side view of another exemplary cable reel in accordance with various aspects of the disclosure.

### DETAILED DESCRIPTION

Reference will now be made in detail to embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

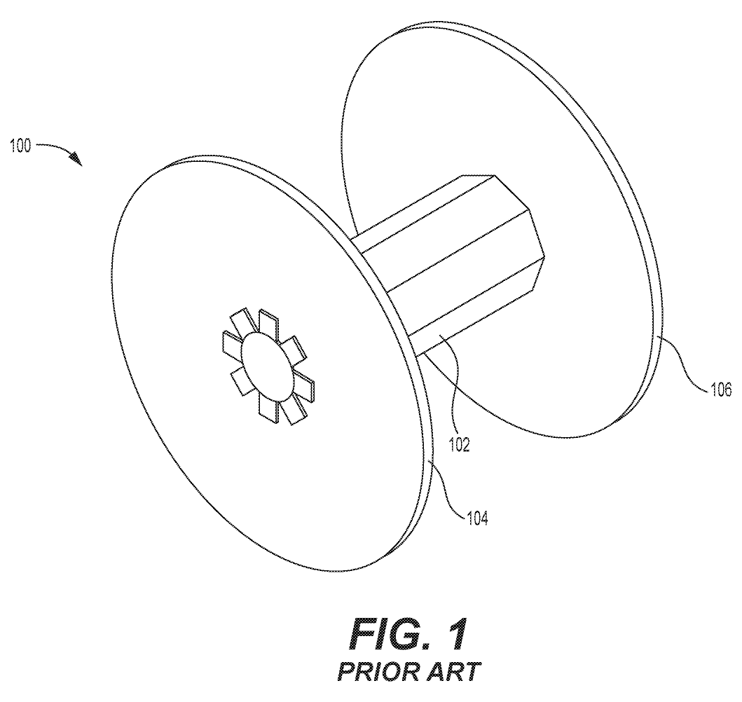

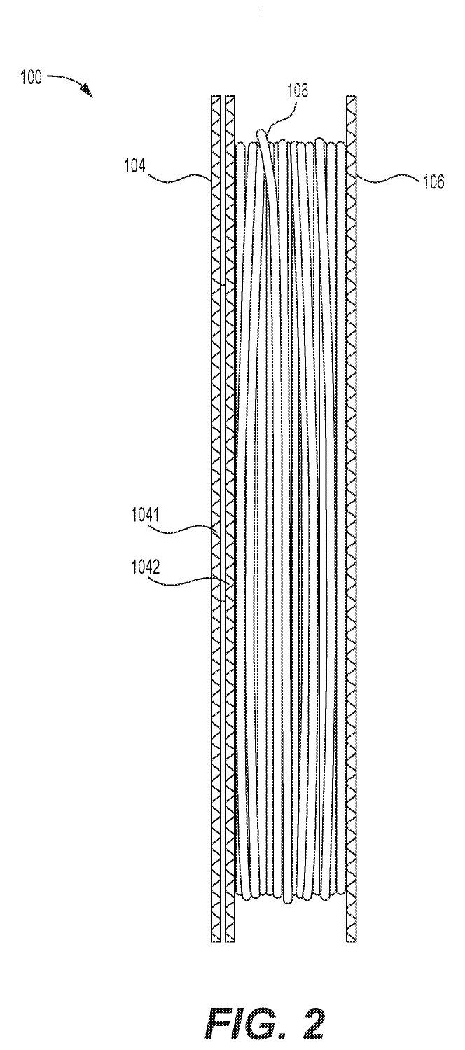

As shown in FIGS. 1 and 2, a conventional cable reel 100 includes a drum 102 and a pair of flanges 104, 106 at each end of the drum 102. The drum 102 comprises a hollow cylinder configured such that the reel 100 can be mounted on a spindle of a reel caddy (not shown) for rotation relative thereto during payout of cable 108 (FIG. 2) from the reel 100. The cable 108 is wound on the drum 102 between the flanges 104, 106. As illustrated, one of the flanges 104 can include two wall portions 1041, 1042 that are separable so as to permit a free end of the cable 108 wound on the drum 102 to be placed between the two wall portions 1041, 1042 such that a technician has easy access to the free end when preparing to pay out cable from the reel 100, as would be understood by persons skilled in the art. As described above, when the cable 108 is paid out from the reel 100, the reel 100 is not able to prevent unintentional unwinding of the cable 108 via the space between the flanges 104, 106.

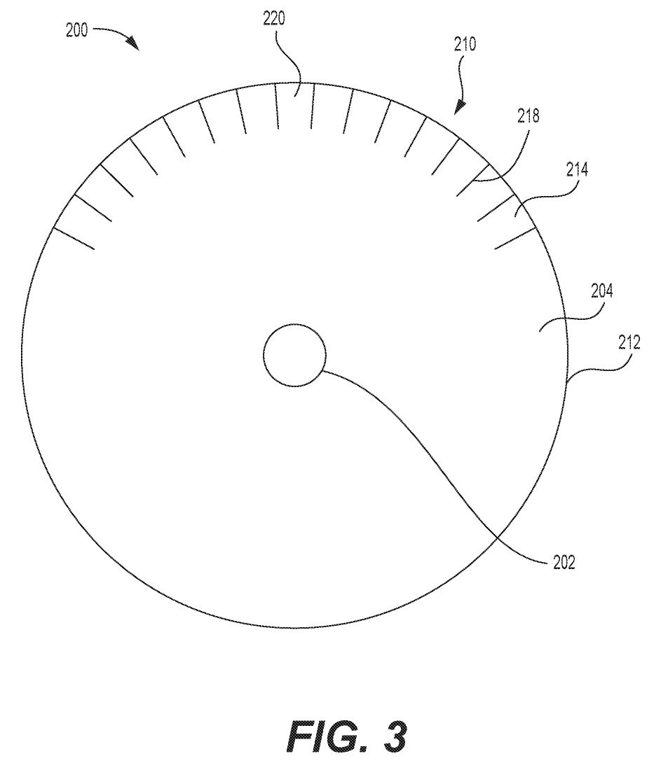

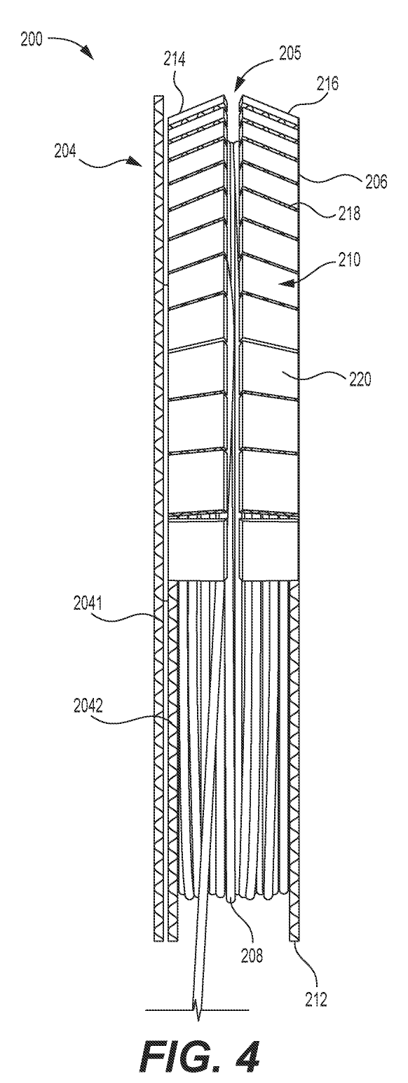

Referring now to FIGS. 3 and 4, an exemplary cable reel 200 in accordance with various aspects of the present disclosure is illustrated. In some embodiments, the cable reel 200 may include a drum portion 202 and a pair of flanges portions 204, 206 at each end of the drum portion 202. In some embodiments, the drum portion 202 may comprise a hollow cylinder configured such that the reel 200 can be mounted on a spindle of a reel caddy (not shown) for rotation relative thereto during payout of cable 208 (FIG. 4) from the reel 200, as would be understood by persons skilled in the art. The drum portion 202 may be structurally configured for the cable 208 to be wound on the drum portion 202 between the flange portions 204, 206. As illustrated, one or both of the flange portions 204 may include two wall portions 2041, 2042 that are separable so as to permit a free end of the cable 208 wound on the drum 202 to be placed between the two wall portions 2041, 2042 such that a technician has easy access to the free end when preparing to pay out cable from the reel 200, as would be understood by persons skilled in the art. In some embodiments, both flange portions 204, 206 may include two wall portions.

As shown in the exemplary embodiment of FIGS. 3 and 4, the cable reel 200 may include a retaining portion 210 structurally configured to be positioned at an outer periphery 212 of the cable reel 200 and to extend into a space 205 between the flange portions 204, 206 radially outward of the cable 208 wound on the drum portion 202. For example, each of the flange portions 204, 206 may comprise a circular flange, and each of the flange portions 204, 206 may include a retaining portion 210 at its outer periphery or circumference 212 (e.g., along at least a portion of the circumference of the flange portions 204, 206) that extends into the space 205 between the flange portions 204, 206, as shown in FIG. 3. In some embodiments, only one of the flange portions 204, 206 may include a retaining portion 210. The retaining portion 210 may extend across a portion of the space 205 or all of the space 205 between the flange portions 204, 206.

In some embodiments, the retaining portion 210 may extend along less than the entire periphery 212 of the cable reel 200. In some embodiments, the retaining portion 210 may include a first retaining portion 214 at the first flange portion 204 and a second retaining portion 216 at the second flange portion 206. In some embodiments, the first and the second retaining portions 214, 216 may be integrally formed with the first and the second flange portions 204, 206, respectively, for example, as single pieces of unitary construction. In some embodiments, cuts, slots, gaps, or the like 218 may be formed in the first and the second flange portions 204, 206 to form the first and second retaining portions 214, 216 (e.g., forming a plurality of tabs, teeth, flaps, projecting portions 220 etc.), respectively.

For example, in some embodiments, the cuts, slots, or gaps 218 may extend radially inward from the outer periphery 212 of the first and the second flange portions 204, 206. The first and second retaining portions 214, 216 may then be folded or bent into the space 205 between the first and the second flange portions 204, 206. However, it should be understood that, in some embodiments, the first and second retaining portions 214, 216 may be formed as separate structures that are configured to be coupled with the first and second flange portions 204, 206 (e.g., at their outer peripheries 212).

In some embodiments, the retaining portion 210 may comprise a material that is sufficiently stiff so as to prevent unintended unwinding, or runaway, of the cable 208 but is sufficiently flexible to permit intended payout of the cable 208. That is, the retaining portion 210 may be structurally configured to provide a radially inward biasing force that is greater than an outward biasing force of the cable 208 wound on the reel 200 that tends to cause the cable 208 to unwind itself from the reel, or run away, when the cable 208 is not being paid out. The biasing force of the retaining portion 210 may be selected such that it can be overcome by a technician during intentional payout of the cable 208 from the reel 200, wherein such intentional payout may cause the retaining portion 210 to deflect radially outward to permit such payout.

The retaining portion 210 may comprise, for example, cardboard, paper, plastic, or other suitable material that is structurally configured to be sufficiently stiff so as to prevent unintended unwinding, or runaway, of the cable 208 but sufficiently flexible to permit intended payout of cable. The first and second flange portions 204, 206 may comprise the same material as the retaining portion 210 or may comprise a different material. For example, in some embodiments, the first and second flange portions 204, 206 may comprise wood, and the retaining portion 210 may comprise cardboard or plastic that is coupled with one or both of the flange portions 204, 206.

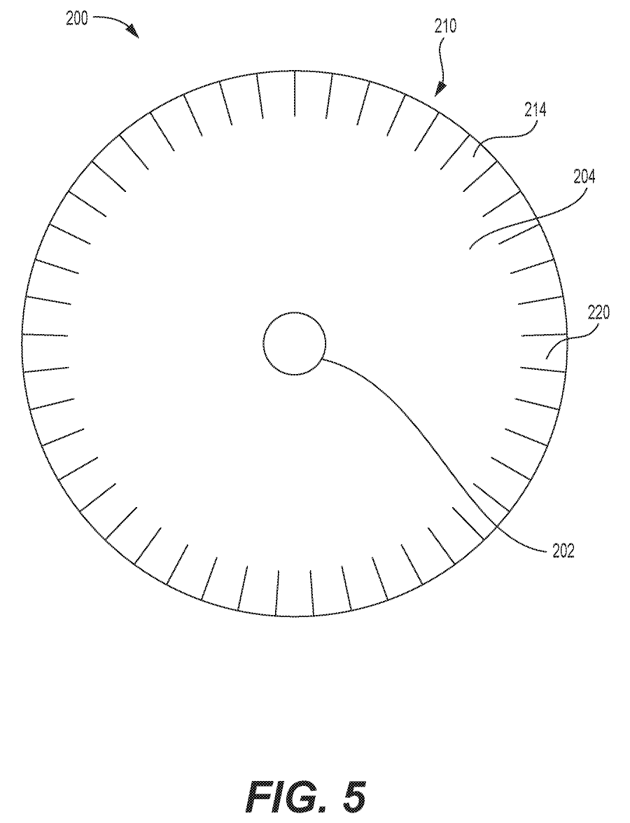

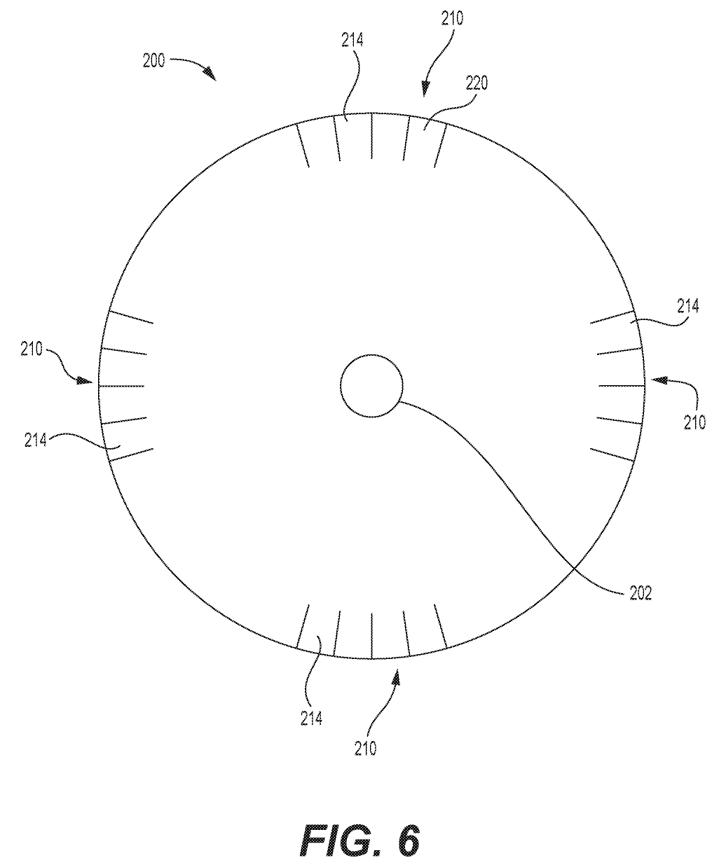

As shown in FIG. 5, in some embodiments, the retaining portion 210, for example, the first retaining portion 214 and/or the second retaining portion 216, may extend about the entire periphery 212 of the first flange portion 204 and/or the second flange portion 206. As shown in FIG. 6, in some embodiments, the retaining portion 210, for example, the first retaining portion 214 and/or the second retaining portion 216, may be circumferentially spaced about all or a portion of the periphery 212 of the first flange portion 204 and/or the second flange portion 206. For example, in FIG. 6, the first retaining portion 214 may include four groups of projecting portions 220, each group centered at approximately 90 degrees apart from an adjacent group.

FIGS. 5 and 6 illustrate an example retaining portion 210 before it is folded or bent into the space between the flange portions 204, 206. Although not illustrated, it should be understood that the first and second retaining portions 214, 216 may be aligned with one another (positioned across from each other) or may be alternately arranged (not positioned across from each other) or any combination thereof.

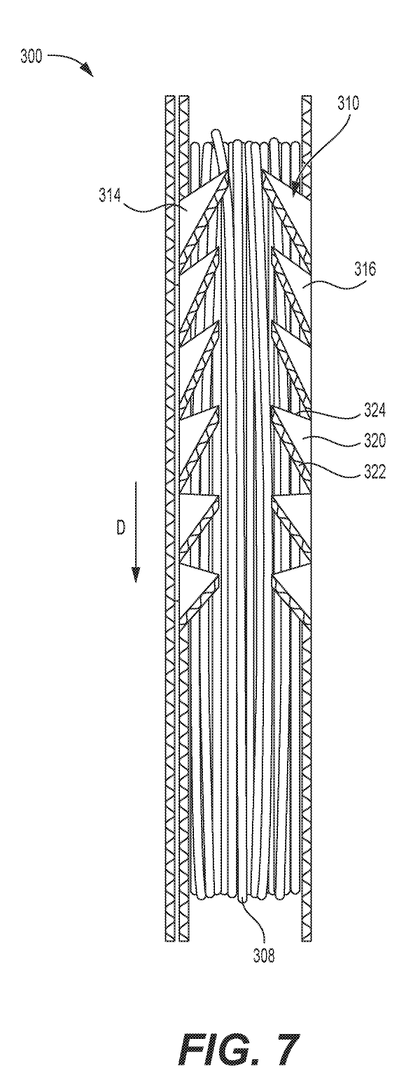

The first and second retaining portions 214, 216 may be shaped in a variety of ways. For example, the first and second retaining portions 214, 216 may include a plurality of rectangular or trapezoidal projecting portions 220, as shown in FIG. 4. In some embodiments, as shown in FIG. 7, a cable reel 300 may include a retaining portion 310 with first and second retaining portion 314, 316 having triangular projecting portions 320 (e.g., tabs, teeth, flaps, projections, etc.). As shown in FIG. 7, each of the projecting portions 320 may include a first or leading edge portion 322 and a second or trailing edge portion 324 opposite the leading edge portion 322. In some embodiments, the leading edge portion 322 may tapers away from a direction D of rotation of the reel 300 as the cable 308 pays out. The tapered shape of the leading edge portion 322 may reduce of the resistance from the projecting portions 320 to the cable 308 paying out and may mitigate the risk of the cable 308 catching or snagging on a projecting portion 320.

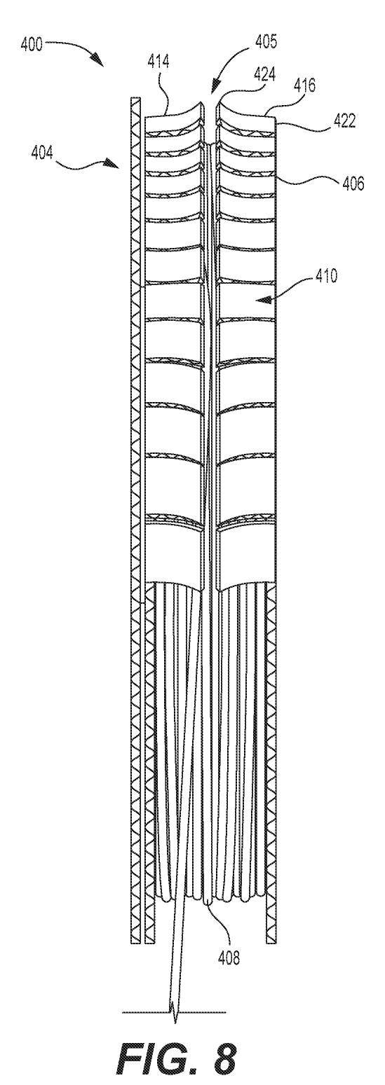

In some embodiments, as shown in FIG. 8, a cable reel 400 may include a retaining portion 410 with first and second retaining portion 414, 416 extending from the first and second flange portions 404, 406, respectively, into the space 405 between the first and second flange portions 404, 406. In some embodiments, the first and second retaining portions 414, 416 may have nonplanar projecting portions 420 (e.g., tabs, teeth, flaps, projections, etc.). As shown in FIG. 8, each of the projecting portions 420 may include a first or leading edge portion 422 and a second or trailing edge portion 424 opposite the leading edge portion 422. In some embodiments, the projecting portions 420 may be curved (e.g., concave) radially outward from the proximal end portion 422 to the distal end portion 424 (i.e., the distal end portion is turned radially outward). The curved shape of the projecting portions 420 may reduce of the resistance from the projecting portions 420 to the cable 408 paying out and may mitigate the risk of the cable 408 catching or snagging on a projecting portion 420.

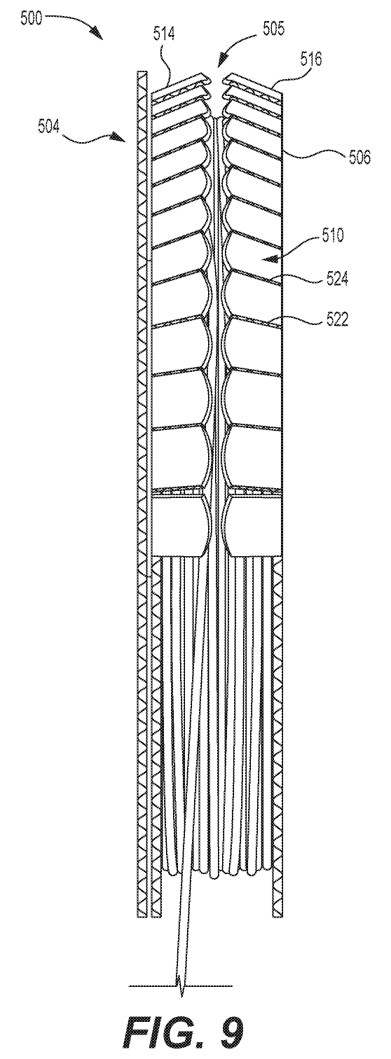

In some embodiments, as shown in FIG. 8, a cable reel 500 may include a retaining portion 510 with first and second retaining portion 514, 516 extending from the first and second flange portions 504, 506, respectively, into the space 505 between the first and second flange portions 504, 506. In some embodiments, the first and second retaining portions 514, 516 may have nonplanar projecting portions 520 (e.g., tabs, teeth, flaps, projections, etc.). As shown in FIG. 9, each of the projecting portions 520 may include a first or leading edge portion 522 and a second or trailing edge portion 524 opposite the leading edge portion 522. In some embodiments, the projecting portions 420 may be curved (e.g., concave) radially inward between the leading edge portion 522 and the trailing edge portion 524 (i.e., the leading edge portion 522 and the trailing edge portion 524 turned radially outward). The degree that projecting portions 420 are curved may vary in different embodiments. The curved shape of the projecting portions 520 may reduce of the resistance from the projecting portions 520 to the cable 508 paying out and may mitigate the risk of the cable 508 catching or snagging on a projecting portion 520.

Of course, it should be understood that a cable reel may include a retaining portion of any shape or size, provided that the retaining portion is configured to maintain cable on the reel so as to prevent unintended payout, or runaway, of cable from the reel. The retaining portion may eliminate the need for plastic packaging to maintain the cable on the reel during transport and storage.

While multiple non-limiting embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A reel structurally configured to prevent unintentional unwinding of cable from the reel, comprising:
a cylindrical drum portion having a first end portion and a second end portion opposite the first end portion, wherein the drum portion is structurally configured to have a cable wound thereon;
a first flange portion structurally configured to be coupled with the first end portion of the drum portion;
a second flange portion structurally configured to be coupled with the second end portion of the drum portion;
a first retaining portion structurally configured to extend from the first flange portion into a space between the first flange portion and the second flange portion;
a second retaining portion structurally configured to extend from the second flange portion into a space between the first flange portion and the second flange portion;
wherein the first retaining portion includes a plurality of first projecting portions positioned along at least a portion of a circumference of the first circular flange portion and structurally configured to extend into the space between the first flange portion and the second flange portion
wherein the second retaining portion includes a plurality of second projecting portions positioned along at least a portion of a circumference of the second circular flange portion and structurally configured to extend from the second flange portion into the space between the first flange portion and the second flange portion;
wherein at least a portion of the retaining portion is structurally configured to deflect radially outward to permit payout of cable wound on the drum portion from the space between the first flange portion and the second flange portion; and
wherein the first and second retaining portions are structurally configured to provide a radially inward biasing force that exceeds a radially outward biasing force of cable wound on the drum portion so as prevent unwinding of cable from the drum portion via the space between the first flange portion and the second flange portion.

2. The reel of claim 1, wherein each of the first and second projecting portions have a leading edge portion and a trailing edge portion opposite the leading edge portion, and are curved inward in a direction from the leading edge portion to the trailing edge portion.

3. The reel of claim 1, wherein the leading edge portion of each of the first and second projecting portions tapers away from a direction of rotation of the reel as the cable pays out.

4. The reel of claim 1, wherein the first retaining portion extends around the entire circumference of the first flange portion.

5. The reel of claim 1, wherein the plurality of first projecting portions are formed integrally with the first flange portion and bent into the space between the first flange portion and the second flange portion;
wherein the plurality of second projecting portions are formed integrally with the second flange portion and bent into the space between the first flange portion and the second flange portion.

6. A reel structurally configured to prevent unintentional unwinding of cable from the reel, comprising:
a drum portion having a first end and a second end;
a first flange portion configured to be coupled with the first end of the drum portion;
a second flange portion configured to be coupled with the second end of the drum portion;
a retaining portion configured to extend into a space between the first flange portion and the second flange portion;
wherein the retaining portion comprises a first retaining portion extending from the first flange portion into the space between the first flange portion and the second flange portion and a second retaining portion extending from the second flange portion into the space between the first flange portion and the second flange portion;
wherein the retaining portion is structurally configured to permit payout of cable wound on the drum portion from the space between the first flange portion and the second flange portion; and
wherein the retaining portion is structurally configured to provide a radially inward biasing force that exceeds a radially outward biasing force of cable wound on the drum portion so as prevent unwinding of cable from the drum portion via the space between the first flange portion and the second flange portion.

7. The reel of claim 6, wherein the first retaining portion comprises a plurality of first projecting portions formed integrally with the first flange portion and bent into the space between the first flange portion and the second flange portion.

8. The reel of claim 7, wherein the second retaining portion comprises a plurality of second projecting portions formed integrally with the second flange portion and bent into the space between the first flange portion and the second flange portion.

9. The reel of claim 6, wherein the first retaining portion includes a first plurality projecting portions, wherein each projecting portion has a leading edge portion, and wherein the leading edge portion tapers away from a direction of rotation of the reel as the cable pays out.

10. The reel of claim 6 wherein the first retaining portion extends around the entire periphery of the first flange portion.

11. The reel of claim 6, wherein at least of portion of the retaining portion is structurally configured to deflect radially outward to permit payout of cable wound on the drum portion.

12. A reel structurally configured to prevent unintentional unwinding of cable from the reel, comprising:
a drum portion having a first end and a second end;
a first flange portion configured to be coupled with the first end of the drum portion;
a second flange portion configured to be coupled with the second end of the drum portion;
a retaining portion configured to extend into a space between the first flange portion and the second flange portion;
wherein the retaining portion is structurally configured to permit payout of cable wound on the drum portion from the space between the first flange portion and the second flange portion; and
wherein the retaining portion is structurally configured to provide a radially inward biasing force that exceeds a radially outward biasing force of cable wound on the drum portion so as prevent unwinding of cable from the drum portion via the space between the first flange portion and the second flange portion.

13. The reel of claim 12, wherein the retaining portion is formed integrally with the first flange portion.

14. The reel of claim 13, wherein the retaining portion is positioned at an outer periphery of the first flange portion and is bent into the space between the first flange portion and the second flange portion.

15. The reel of claim 14, wherein the retaining portion includes a second retaining portion formed integrally with the second flange portion.

16. The reel of claim 15, wherein the second retaining portion is positioned at an outer periphery of the second flange portion and is bent into the space between the first flange portion and the second flange portion.

17. The reel of claim 12, wherein the retaining portion includes a plurality of projecting portions, and wherein each projecting portion has a leading edge portion that tapers away from a direction of rotation of the reel as the cable pays out.

18. The reel of claim 12, wherein the retaining portion includes a plurality of projecting portions, wherein each projecting portion has a leading edge portion and a trailing edge portion, and wherein the projecting portion is curved inward in a direction from the leading edge portion to the trailing edge portion.

19. The reel of claim 12, wherein the retaining portion extends around the entire periphery of the first flange portion.

20. The reel of claim 12, wherein at least a portion of the retaining portion is structurally configured to deflect radially outward to permit payout of cable wound on the drum portion.

21. The reel of claim 12, wherein the retaining portion comprises a first retaining portion extending from the first flange portion into the space between the first flange portion and the second flange portion and a second retaining portion extending from the second flange portion into the space between the first flange portion and the second flange portion.
